(19) United States
(12) Patent Application Publication
(10) Pub. No.: US 2022/0036378 A1
(43) Pub. Date: Feb. 3, 2022

(54) CUSTOMER INTERACTION SYSTEMS AND METHODS

(71) Applicant: salesforce.com, Inc., San Francisco, CA (US)

(72) Inventors: Jeremy Roberts, Sydney (AU); Milly Good, Sydney (AU); Anjanjot Kaur, Sydney (AU)

(73) Assignee: salesforce.com, Inc., San Francisco, CA (US)

(21) Appl. No.: 16/947,347

(22) Filed: Jul. 29, 2020

(51) Int. Cl. G06Q 30/02; G06K 9/00; H04W 4/12

(52) U.S. Cl. CPC G06Q 30/0201; H04W 4/12; G06K 9/00362

(57) ABSTRACT

Methods and systems for interacting with a user to build a customer profile include: receiving, by a processor, an identifier of the user; retrieving, by the processor, personal information of the user from a database system based on the identifier; recognizing, by the processor, preference information of the user from an image of the user; obtaining, by the processor, additional preference information of the user by managing a dialog between the user and a mirror display system; and storing, by the processor, the customer profile based on the personal information, the preference information, and the additional dialog information.

### TECHNICAL FIELD

Embodiments of the subject matter described herein relate generally to interaction systems, and more particularly to methods and systems for promoting interaction between clients or customers and an organization to build customer profiles.

### BACKGROUND

An organization typically obtains information about potential clients or customers in order to develop marketing strategies. In some instances, the information is stored in a database that is not available without permissions. In some instances, the information is available but not organized in a manner that is beneficial for marketing analysis.

Accordingly, it would be desirable to provide improved systems and methods that interact with users to build customer profiles.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary interaction management system that may be implemented in the context of a computing environment, in accordance with various embodiments.

FIGS. 2, 3, and 4 are sequence diagrams depicting example processes that may be performed by the interaction management system for managing interactions, in accordance with various embodiments;

FIG. 5 is a dataflow diagram depicting an example system of the interaction management system for managing interactions between customers and a database system in order to build customer profiles, in accordance with various embodiments; and

FIG. 6 is a block diagram of the example interaction management system that may be implemented in the context of a multi-tenant system as the computing environment, in accordance with various embodiments.

### DETAILED DESCRIPTION

Disclosed herein are systems and methods for managing interactions between a customer and a database in order to build customer profiles. More particularly, the subject matter described herein discloses apparatus, systems, techniques and articles for managing interactions between a customer and a database in order to build customer profiles. The subject matter described herein further discloses apparatus, systems, techniques and articles for managing interactions between a customer and a database in order to build customer profiles. The disclosure provides many different embodiments, or examples, for implementing different features of the provided subject matter. The following detailed description is merely exemplary in nature and is not intended to limit the invention or the application and uses of the invention. Furthermore, there is no intention to be bound by any theory presented in the preceding background or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

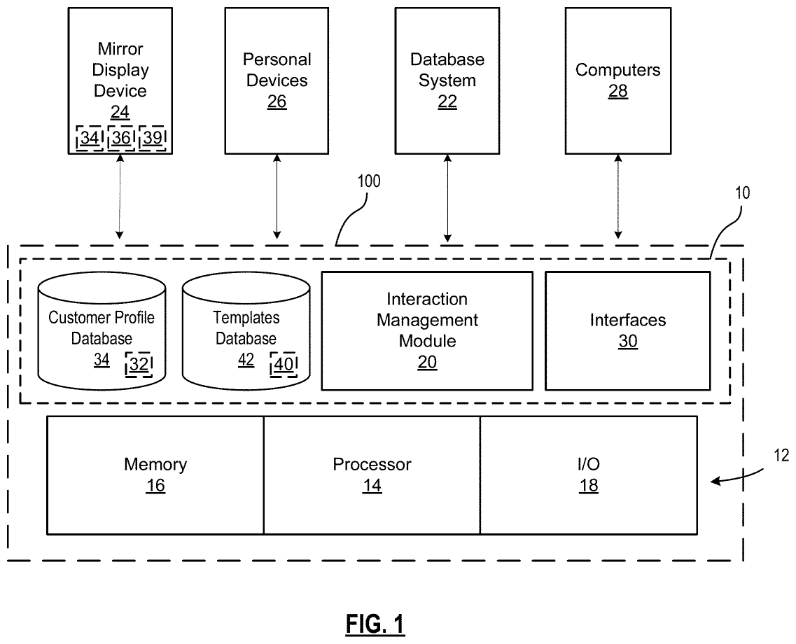

Turning now to the figures where an interaction management system 10 is shown and described in accordance with various embodiments. With particular reference to FIG. 1, in various embodiments, the exemplary interaction management system 10 may be implemented in the context of a computing environment 100. The computing environment 100 operates with any sort of conventional processing hardware 12, such as a processor 14, memory 16, input/output features 18 and the like. The input/output features 18 generally represent the interface(s) to networks (e.g., to a network, or any other local area, wide area or other network), mass storage, display devices, data entry devices and/or the like. The processor 14 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 16 represents any non-transitory short or long term storage or other computer-readable media capable of storing programming instructions for execution on the processor 14, including any sort of random access memory (RAM), read only memory (ROM), flash memory, magnetic or optical mass storage, and/or the like. The computer-executable programming instructions, when read and executed by the processor 14, cause the processor 14 to create, generate, or otherwise facilitate tasks, operations, functions, and/or processes described herein. It should be noted that the memory 16 represents one suitable implementation of such computer-readable media, and alternatively or additionally, the processor 14 could receive and cooperate with external computer-readable media that is realized as a portable or mobile component or application platform, e.g., a portable hard drive, a USB flash drive, an optical disc, or the like.

The interaction management system 10 is shown to include an interaction management module 20 that communicates with a database system 22, a mirror display system 24, personal devices 26, and/or computers 28 via one or more interfaces 30 in order to build and store customer profiles 32 in a customer database 34. In various embodiments, the mirror display system 24 includes a display screen having a reflective surface configured to mirror the image in front of the display and configured to permit display of text messages. In various embodiments, the mirror display system 24 further includes a camera 36, and/or a microphone 38 configured to capture information from a user. In various embodiments, the mirror display system 24 further includes a speaker 39 configured to present information to the user.

In various embodiments, the personal devices 26 include any personal device associated with users, such as a cell phone or tablet that is configured to receive text messages and/or email messages. In various embodiments, the computers 28 include any type of computing device having input/output devices configured to display information and receive configuration parameters from users.

In various embodiments, the interaction management system 10 communicates with the various devices 22-28 in order to obtain personal information about customers and to build the customer profile 32. The interaction management system 10 stores the customer profiles 32 in the customer database 34. The interaction management system 10 communicates with the various devices 22-28 in order to provide organization information to the users based on the stored customer profile 32.

In various embodiments, the interaction management system 10 communicate with the various devices 22-28 in order to build dialog templates 40 for use in interacting with the user. The interaction management system 10 stores the dialog templates 40 in a templates database 42.

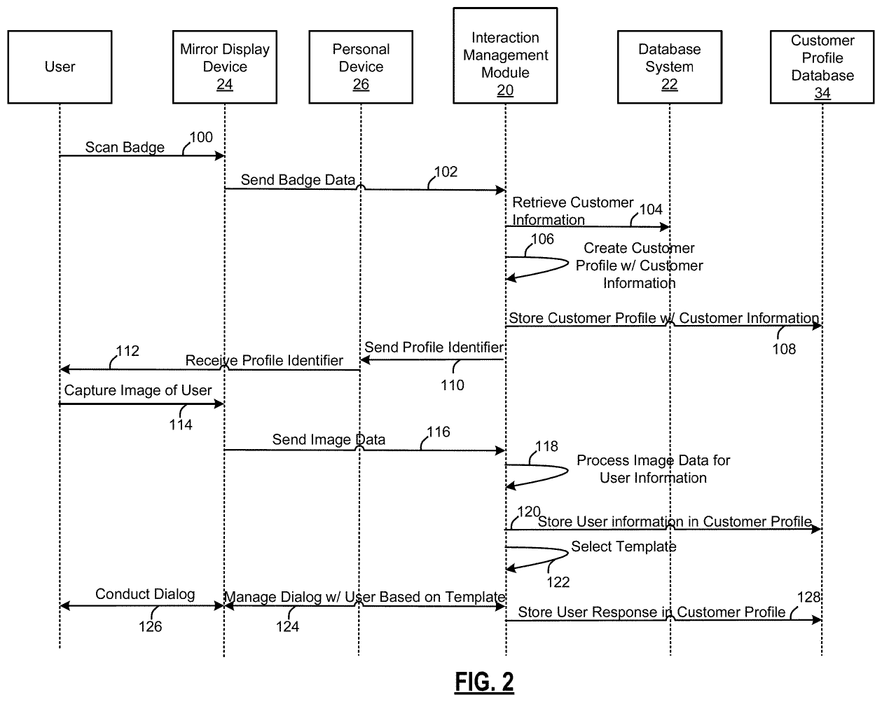

With reference now to FIGS. 2-4 and with continued reference to FIG. 1, sequence diagrams illustrate various use case workflows of the interaction management system 10 for interacting with a user to create customer profiles 32 and to distribute organization information based on the customer profiles 32. In accordance with an exemplary use case workflow for creating a customer profile 32 as shown in FIG. 2, a user of the interaction management system 10 interacts with the interaction management module 20 via the mirror display system 24 and/or the personal device 26. For example, the user initiates the interaction at 100 by scanning a badge having a unique identifier (e.g., bar code, QR code, etc.) associated with the user via, for example, the personal device 26 or the camera of the mirror display system 24. In response, the personal device 26 or the mirror display system 24 sends the scanned badge data to the interaction management module 20 at 102. By scanning, the badge, the user is giving permission to the system 10 to have access to the user's personal information stored by the organization.

Thereafter, the interaction management module 20 interacts with the database system 22 to obtain the personal contact information of the user associated with the unique identifier at 104. The interaction management module 20 creates a customer profile by assigning a unique profile identifier and using the obtained personal contact information at 106. The interaction management module 20 stores the customer profile in the customer profile database 34 at 108 and sends the unique profile identifier to the user via, for example the personal device 26 at 110.

Thereafter, the user receives the unique profile identifier at 112. The user permits the mirror display system 24 to obtain an image by standing in front of the mirror display system 24 and, optionally, holding a prop and/or speaking a defined prompt (e.g., “Hi”, “My unique code is . . . ”, etc.) at 114. The mirror display system 24 sends the image data to the interaction management module 20 at 116. The interaction management module 20 analyzes the image data for information about the user, for example, using various image recognition techniques at 118, and stores the information obtained from the image in the customer profile of the customer profile database 34 at 120.

For example, the image may be analyzed to identify a type of the prop held by the user, a type or style of clothing worn by the user, a color and/or style of hair of the user, an age of the user, or any other feature that may be used to determine preferences of the user.

Thereafter, the interaction management module 20 selects a template, for example, based on what was identified in the image at 122 and then manages a dialog with the user via the mirror display system 24 to obtain additional user preference information at 124, 126.

As can be appreciated, any number of prompts and user responses can be exchanged between the user and the mirror display system 24, depending on the information in the selected template. In one example, the organization is a vacation sales entity. In such example, an object type is determined from the image based on a prop (e.g., a wine bottle, a teddy bear, sunglasses, toy boat, plant, toy car, clock, etc.) held by the user when the image was captured. The object type is matched to a vacation type or types (e.g., adults only, all inclusive, boutique, city break, cruises, family friendly, group, homes and villas, honeymoon, relaxed, romantic, short stay, spa break, sun and beach, sustainable travel, tours, tours and cruises, tours by luxury escape, villa, etc.) and a dialog is held with the user to determine preferences (e.g., region of interest, duration of stay, etc.) for that particular vacation type. The dialog is held between the user and the mirror display system 24 by displaying prompts to the user and recognizing voice and/or images of the user in response to the displayed prompts. The additional preference information obtained from the user is then stored in the customer profile 32 of the customer profile database 34 at 128.

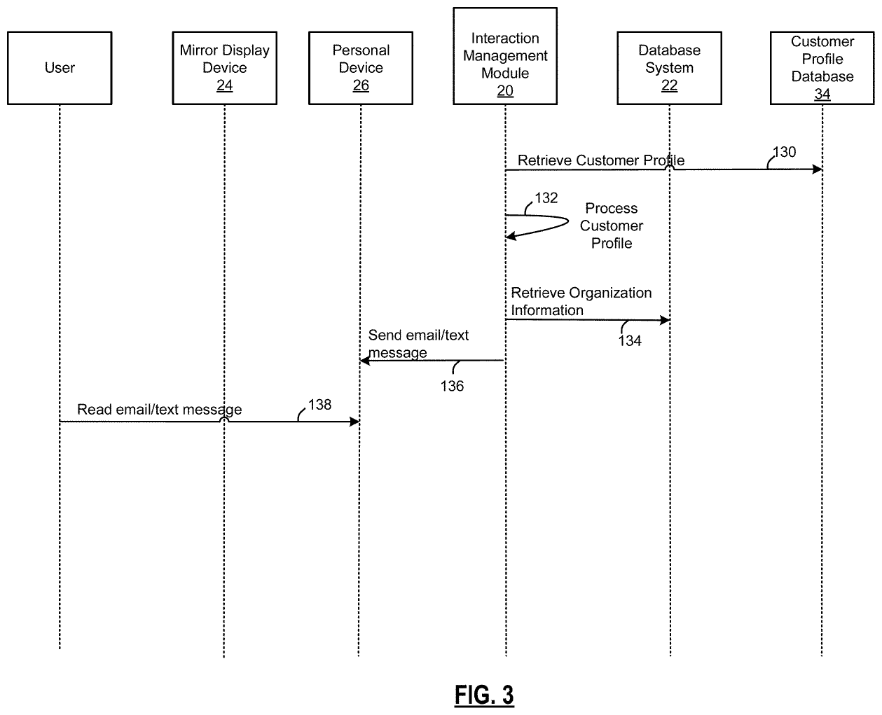

In accordance with another exemplary use case workflow for providing organization information as shown in FIG. 3, the interaction management module 20 retrieves the customer profile 32 from the customer profile database 34 at 130. The interaction management module 20 analyzes the customer profile 32 for preferences at 132 and retrieves organization information from the database system 22 based on the preferences at 134. Thereafter, the interaction management module 20 provides organization information that is based on the user preferences to the user in the form of an email or text messages via the personal device 26 at 136. The user receives the email or text messages at 138.

For example, an email or text message may be sent containing a link to purchase one or more items that match the user preferences. Provided the vacation example above, an email or text message can be sent that contains a link to the entities' website and a list of vacations that match the user's preferences.

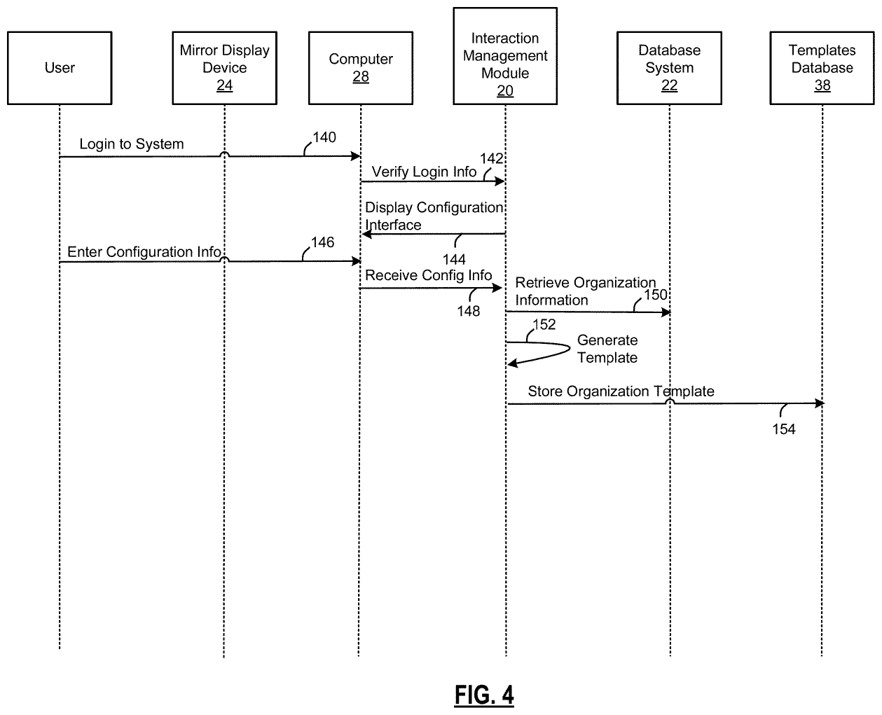

In accordance with an exemplary use case workflow for building dialog templates 40 as shown in FIG. 4, a user of the interaction management system 10, such as an engineer of the organization, interacts with the interaction management module 20 via the computer 28. For example, the user logs into the interaction management system 10 using the computer 28 at 140. The interaction management module 20 receives and verifies the login at 142 and presents one or more template configuration interfaces to the user via the computer 28 at 144. The user views the configuration interfaces and enters configuration information at 146. The interaction management module 20 receives the configuration information at 148 and retrieves organization information from the database system 22 at 150. The interaction management module 20 generates one or more dialog templates 40 based on the configuration information and the organization information at 152. The interaction management module 20 stores the dialog templates 40 in the templates database 42 at 154.

As can be appreciated, the configuration information can vary depending on the type of organization. Provided the vacation example above, the configuration information can include a mapping of the props to the vacation types. The configuration information may further include prompts or questions relating to vacations.

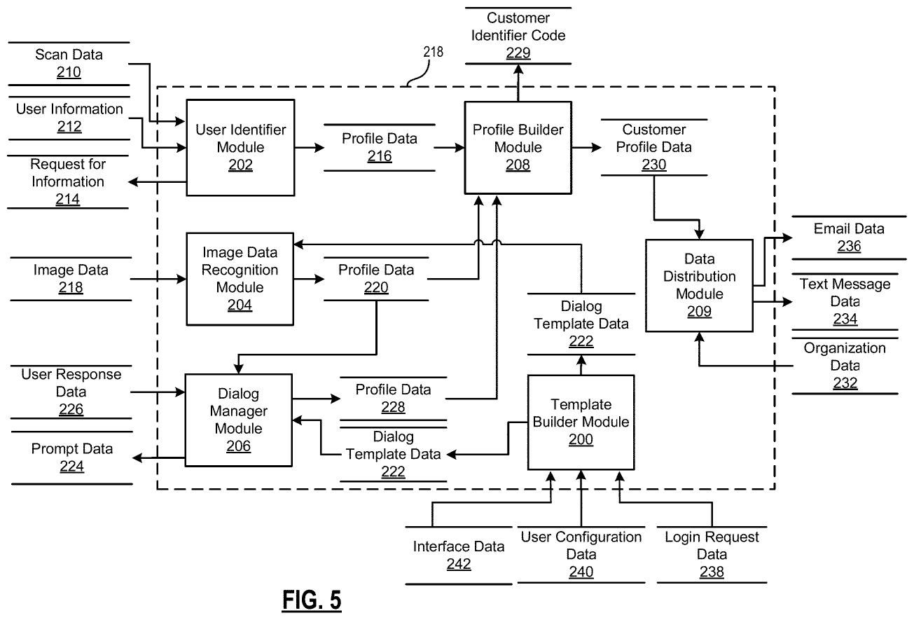

With reference now to FIG. 5, a dataflow diagram depicts an exemplary interaction management module 20 for building customer profiles 32. As can be appreciated, various exemplary embodiments of the interaction management module 20, according to the present disclosure, may include any number of modules and/or sub-modules. In various exemplary embodiments, the modules and sub-modules shown in FIG. 5 may be combined and/or further partitioned to similarly build customer profiles 32. In various embodiments, the interaction management module 20 includes a template builder module 200, a user identifier module 202, an image data recognition module 204, a dialog manager module 206, a profile builder module 208, and a data distribution module 209.

The user identifier module 202 receives the scan data 210 resulting from the scanning of the user's badge. In various embodiments, the user identifier module 202 processes the scan data 210 to determine the unique identifier. In various other embodiments, the scan data 210 is the unique identifier. The user identifier module 202 obtains the user information 212 associated with the unique identifier by issuing a request for information 214 to the database system 22. In response, the user identifier module 202 receives the user information 212 from the database system 22. The user identifier module 202 provides the user information 212 as profile data 216 to the profile builder module 208.

The image data recognition module 204 receives as input image data 218 and dialog template data 222. The image data 218 includes a captured image or video of the user interacting with the mirror display system 24. The image data recognition module 204 processes the image data 218 using one or more image recognition techniques to identify facial features, hair color, clothing, accessories, an object that is being held by the user, a background selected by the user, or some other element of the image that identifies a user's preferences. The image recognition technique is selected for use based on the configuration parameters provided by the dialog template data 222 (e.g., props, facial features, clothing, etc.). The image data recognition module 204 provides the identified features as profile data 220 to the profile builder module 208.

The dialog manager module 206 receives as input the profile data 220 identified from the images. The dialog manager module 206 retrieves dialog template data 222 from the templates database (e.g., via the template builder module 200) based on the user preferences. The dialog manager module 206 manages a dialog with the user by generating prompt data 224 to the mirror display system 24 and receiving response data from the mirror display device (e.g., from the microphone and/or camera). The dialog manager module 206 identifies additional preferences of the user based on the response data 226. The dialog manager module 206 provides the identified additional preferences as profile data 228 to the profile builder module 208.

The profile builder module 208 receives the profile data 216, the profile data 220, and the profile data 228. The profile builder module 208 creates a customer identifier code 229 and communicates the customer identifier code 229 to the user via text or email. The profile builder module 208 creates a customer profile 32 for the user based on the received profile data 216, 220, 228 and the customer identifier code 229. The profile builder module 208 stores the customer profile data 230 in the customer profile database 34.

The data distribution module 209 receives the customer profile data 230. The data distribution module 209 retrieves organization data 232, for example, from the database system 22 based on the customer profile data 230. For example, the data distribution module 209 retrieves organization data 232 that matches with the user's preferences. The data distribution module 209 distributes the organization data 232 to the user via text message data 234 and/or email data 236.

The template builder module 200 receives login request data 238, and user configuration data. Upon verification of the login request data 238, the template builder module 200 builds dialog templates with the user configuration data 240 and optionally, organization data retrieved from, for example, the database system 22. The template builder module 200 stores the dialog template data 222 in the templates database 42 and provides the dialog template data 222 to the dialog manager module 206 and the image data recognition module 204.

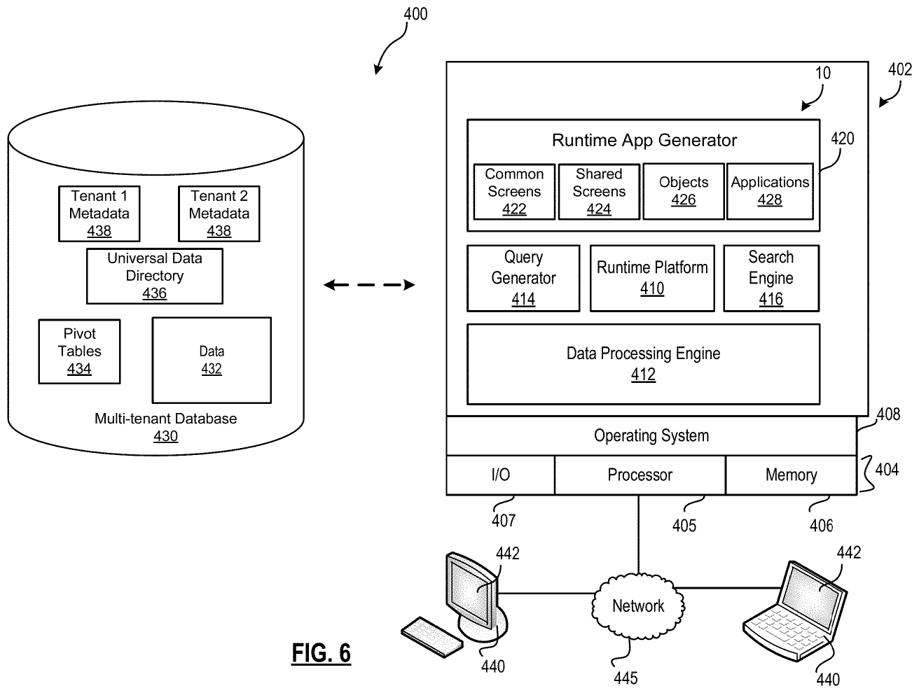

With particular reference to FIG. 6, in various embodiments, the exemplary interaction management system 10 may be implemented in the context of a multi-tenant database system 400. As can be appreciated, the interaction management system 10 may be implemented in other systems such as a single tenant system or a personal computing system and is not limited to the present example. For exemplary purposes, the interaction management system 10 will be discussed hereinafter in the context of the multi-tenant system 400.

The example multi-tenant system 400 of FIG. 6 includes a server 402 that dynamically creates and supports virtual applications 428 based upon data 432 from a common database 430 that is shared between multiple tenants, alternatively referred to herein as a multi-tenant database. Data and services generated by the virtual applications 428 are provided via a network 445 to any number of client devices 440, as desired. Each virtual application 428 is suitably generated at run-time (or on-demand) using a common application platform 410 that securely provides access to the data 432 in the database 430 for each of the various tenants subscribing to the multi-tenant system 400.

As used herein, a “tenant” or an “organization” should be understood as referring to a group of one or more users or entities that shares access to common subset of the data within the multi-tenant database 430. In this regard, each tenant includes one or more users associated with, assigned to, or otherwise belonging to that respective tenant. To put it another way, each respective user within the multi-tenant system 400 is associated with, assigned to, or otherwise belongs to a particular tenant of the plurality of tenants supported by the multi-tenant system 400. Tenants may represent customers, customer departments, business or legal organizations, and/or any other entities that maintain data for particular sets of users within the multi-tenant system 400 (i.e., in the multi-tenant database 430). For example, the application server 402 may be associated with one or more tenants supported by the multi-tenant system 400. Although multiple tenants may share access to the server 402 and the database 430, the particular data and services provided from the server 402 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 432 belonging to or otherwise associated with other tenants.

In various embodiments, the server 402 is implemented using one or more actual and/or virtual computing systems that collectively provide the dynamic application platform 410 for generating the virtual applications 428. For example, the server 402 may be implemented using a cluster of actual and/or virtual servers operating in conjunction with each other, typically in association with conventional network communications, cluster management, load balancing and other features as appropriate. The server 402 operates with any sort of conventional processing hardware 404, such as a processor 405, memory 406, input/output features 407 and the like. The input/output features 407 generally represent the interface(s) to networks (e.g., to the network 445, or any other local area, wide area or other network), mass storage, display devices, data entry devices and/or the like. The processor 405 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 406 represents any non-transitory short or long term storage or other computer-readable media capable of storing programming instructions for execution on the processor 405, including any sort of random access memory (RAM), read only memory (ROM), flash memory, magnetic or optical mass storage, and/or the like. The computer-executable programming instructions, when read and executed by the server 402 and/or processor 405, cause the server 402 and/or processor 405 to create, generate, or otherwise facilitate the application platform 410 and/or virtual applications 428 and perform one or more additional tasks, operations, functions, and/or processes described herein. It should be noted that the memory 106 represents one suitable implementation of such computer-readable media, and alternatively or additionally, the server 402 could receive and cooperate with external computer-readable media that is realized as a portable or mobile component or application platform, e.g., a portable hard drive, a USB flash drive, an optical disc, or the like.

The application platform 410 is any sort of software application or other data processing engine that generates the virtual applications 428 that provide data and/or services to the client devices 440. In a typical embodiment, the application platform 410 gains access to processing resources, communications interfaces and other features of the processing hardware 104 using any sort of conventional or proprietary operating system 408. The virtual applications 128 are typically generated at run-time in response to input received from the client devices 440. For the illustrated embodiment, the application platform 410 includes a bulk data processing engine 412, a query generator 414, a search engine 416 that provides text indexing and other search functionality, and a runtime application generator 420. Each of these features may be implemented as a separate process or other module, and many equivalent embodiments could include different and/or additional features, components or other modules as desired.

The runtime application generator 420 dynamically builds and executes the virtual applications 428 in response to specific requests received from the client devices 440. The virtual applications 428 are typically constructed in accordance with the tenant-specific metadata 438, which describes the particular tables, reports, interfaces and/or other features of the particular application 428. In various embodiments, each virtual application 428 generates dynamic web content that can be served to a browser or other client program 442 associated with its client device 440, as appropriate.

The runtime application generator 420 suitably interacts with the query generator 414 to efficiently obtain multi-tenant data 432 from the database 430 as needed in response to input queries initiated or otherwise provided by users of the client devices 440. In a typical embodiment, the query generator 414 considers the identity of the user requesting a particular function (along with the user's associated tenant), and then builds and executes queries to the database 430 using system-wide metadata 436, tenant specific metadata 438, pivot tables 434, and/or any other available resources. The query generator 414 in this example therefore maintains security of the common database 430 by ensuring that queries are consistent with access privileges granted to the user and/or tenant that initiated the request. In this manner, the query generator 414 suitably obtains requested subsets of data 432 accessible to a user and/or tenant from the database 430 as needed to populate the tables, reports or other features of the particular virtual application 428 for that user and/or tenant.

Still referring to FIG. 6, the data processing engine 412 performs bulk processing operations on the data 432 such as uploads or downloads, updates, online transaction processing, and/or the like. In many embodiments, less urgent bulk processing of the data 432 can be scheduled to occur as processing resources become available, thereby giving priority to more urgent data processing by the query generator 414, the search engine 416, the virtual applications 428, etc.

In exemplary embodiments, the application platform 410 is utilized to create and/or generate data-driven virtual applications 428 for the tenants that they support. Such virtual applications 428 may make use of interface features such as custom (or tenant-specific) screens 424, standard (or universal) screens 422 or the like. Any number of custom and/or standard objects 426 may also be available for integration into tenant-developed virtual applications 428. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 426 such as “account” objects, “opportunity” objects, “contact” objects, or the like. The data 432 associated with each virtual application 428 is provided to the database 430, as appropriate, and stored until it is requested or is otherwise needed, along with the metadata 438 that describes the particular features (e.g., reports, tables, functions, objects, fields, formulas, code, etc.) of that particular virtual application 428. For example, a virtual application 428 may include a number of objects 426 accessible to a tenant, wherein for each object 426 accessible to the tenant, information pertaining to its object type along with values for various fields associated with that respective object type are maintained as metadata 438 in the database 430. In this regard, the object type defines the structure (e.g., the formatting, functions and other constructs) of each respective object 426 and the various fields associated therewith.

Still referring to FIG. 6, the data and services provided by the server 402 can be retrieved using any sort of personal computer, mobile telephone, tablet or other network-enabled client device 440 on the network 445. In an exemplary embodiment, the client device 440 includes a display device, such as a monitor, screen, or another conventional electronic display capable of graphically presenting data and/or information retrieved from the multi-tenant database 430. Typically, the user operates a conventional browser application or other client program 442 executed by the client device 440 to contact the server 402 via the network 445 using a networking protocol, such as the hypertext transport protocol (HTTP) or the like. The user typically authenticates his or her identity to the server 402 to obtain a session identifier (“SessionID”) that identifies the user in subsequent communications with the server 402. When the identified user requests access to a virtual application 428, the runtime application generator 420 suitably creates the application at run time based upon the metadata 438, as appropriate. As noted above, the virtual application 428 may contain Java, ActiveX, or other content that can be presented using conventional client software running on the client device 440; other embodiments may simply provide dynamic web or other content that can be presented and viewed by the user, as desired.

The multi-tenant database 430 is any sort of repository or other data storage system capable of storing and managing the data 432 associated with any number of tenants. The database 430 may be implemented using any type of conventional database server hardware. In various embodiments, the database 430 shares processing hardware 404 with the server 402. In other embodiments, the database 430 is implemented using separate physical and/or virtual database server hardware that communicates with the server 402 to perform the various functions described herein. In an exemplary embodiment, the database 430 includes a database management system or other equivalent software capable of determining an optimal query plan for retrieving and providing a particular subset of the data 432 to an instance of virtual application 428 in response to a query initiated or otherwise provided by a virtual application 428. The multi-tenant database 430 may alternatively be referred to herein as an on-demand database, in that the multi-tenant database 430 provides (or is available to provide) data at run-time to on-demand virtual applications 428 generated by the application platform 410.

In practice, the data 432 may be organized and formatted in any manner to support the application platform 410. In various embodiments, the data 432 is suitably organized into a relatively small number of large data tables to maintain a semi-amorphous “heap”-type format. The data 432 can then be organized as needed for a particular virtual application 428. For example, conventional data relationships can be established using any number of pivot tables 434 that establish indexing, uniqueness, relationships between entities, and/or other aspects of conventional database organization as desired. Further data manipulation and report formatting is generally performed at run-time using a variety of metadata constructs. Metadata within a universal data directory (UDD) 436, for example, can be used to describe any number of forms, reports, workflows, user access privileges, business logic and other constructs that are common to multiple tenants. Tenant-specific formatting, functions and other constructs may be maintained as tenant-specific metadata 438 for each tenant, as desired. Rather than forcing the data 432 into an inflexible global structure that is common to all tenants and applications, the database 430 is organized to be relatively amorphous, with the pivot tables 434 and the metadata 438 providing additional structure on an as-needed basis. To that end, the application platform 410 suitably uses the pivot tables 434 and/or the metadata 438 to generate “virtual” components of the virtual applications 428 to logically obtain, process, and present the relatively amorphous data 432 from the database 430.

The interaction management system 10 disclosed herein provides for methods, systems, and techniques for processing the data 432 to build templates, to build customer profiles, and to distribute organization information. In various embodiments, the interaction management system 10 may be implemented as part of one of the virtual applications 428 and/or part of the data processing engine 412.

Disclosed herein are systems and methods for interacting with a user to build a customer profile. In one embodiment, a computer implemented method of interacting with a user to build a customer profile is provided. The method includes: receiving, by a processor, an identifier of the user; retrieving, by the processor, personal information of the user from a database system based on the identifier; recognizing, by the processor, preference information of the user from an image of the user; obtaining, by the processor, additional preference information of the user by managing a dialog between the user and a mirror display system; and storing, by the processor, the customer profile based on the personal information, the preference information, and the additional dialog information.

These aspects and other embodiments may include one or more of the following features.

In various embodiments, the managing the dialog is based on a dialog template that is selected from a plurality of dialog templates.

In various embodiments, the method includes selecting, by the processor, the dialog template from the plurality of dialog templates based on the preference information.

In various embodiments, the method includes selecting, by the processor, the dialog template from the plurality of dialog templates based on organization information.

In various embodiments, the method includes configuring, by the processor, the dialog template based on a configuration interface and input entered by a user.

In various embodiments, the method includes communicating, by the processor, organization information to the user based on the customer profile. In various embodiments, the method includes communicating by way of text messages. In various embodiments, the method includes communicating by way of email messages.

In various embodiments, the recognizing includes, recognizing a feature of the user from the image of the user, and associating a preference of the user based on the recognized feature. In various embodiments, the recognizing includes, recognizing a prop held by the user from the image of the user, and associating a preference of the user based on the recognized prop.

In various embodiments, the method includes scanning a badge of the user to produce scan data, and wherein the scan data includes the identifier of the user.

In another embodiment, a computer-implemented system is provided. The system includes: a mirror display system configured to conduct a dialog with the user; a non-transitory computer readable medium configured to store the customer profile; and a processor. The processor is configured to: receive an identifier of the user, retrieve personal information of the user from a database system based on the identifier, recognize preference information of the user from an image of the user, obtain additional preference information of the user by managing a dialog between the user and the mirror display system, and store the customer profile based on the personal information, the preference information, and the additional dialog information.

These aspects and other embodiments may include one or more of the following features. In various embodiments, the system includes a second non-transitory computer readable medium configured to store a plurality of dialog templates, and wherein the processor manages the dialog based on a dialog template that is selected from the plurality of dialog templates.

In various embodiments, the processor is further configured to select the dialog template from the plurality of dialog templates based on the preference information.

In various embodiments, the processor is further configured to select the dialog template from the plurality of dialog templates based on organization information. In various embodiments, the processor is further configured to communicate organization information to the user based on the customer profile.

In various embodiments, the communicating is by way of at least one of text messages and email.

In various embodiments, the processor is configured to recognize a feature of the user from the image of the user and associate a preference of the user based on the recognized feature.

In various embodiments, the processor is configured to recognize a prop held by the user from the image of the user and associate a preference of the user based on the recognized prop.

In another embodiment, a multi-tenant system is provided. The multi-tenant enterprise system comprises one or more processors and non-transient computer readable media coupled to the one or more processors wherein the non-transient computer readable media embodies programming instructions configurable to perform a method. The method includes: receiving, by a processor, an identifier of a user; retrieving, by the processor, personal information of the user from a database system based on the identifier; recognizing, by the processor, preference information of the user from an image of the user; obtaining, by the processor, additional preference information of the user by managing a dialog between the user and a mirror display system; and storing, by the processor, a customer profile based on the personal information, the preference information, and the additional dialog information.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to object models, web pages, multi-tenancy, cloud computing, on-demand applications, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first,” “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary embodiments, the subject matter described herein is implemented in conjunction with a virtual customer relationship management (CRM) application in a multi-tenant environment.

While at least one exemplary embodiment has been presented, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A computer implemented method of interacting with a user to build a customer profile, the method comprising:
receiving, by a processor, an identifier of the user;
retrieving, by the processor, personal information of the user from a database system based on the identifier;
recognizing, by the processor, preference information of the user from an image of the user;
obtaining, by the processor, additional preference information of the user by managing a dialog between the user and a mirror display system; and
storing, by the processor, the customer profile based on the personal information, the preference information, and the additional dialog information.

2. The method of claim 1, wherein the managing the dialog is based on a dialog template that is selected from a plurality of dialog templates.

3. The method of claim 2, further comprising selecting, by the processor, the dialog template from the plurality of dialog templates based on the preference information.

4. The method of claim 2, further comprising selecting, by the processor, the dialog template from the plurality of dialog templates based on organization information.

5. The method of claim 2, further comprising configuring, by the processor, the dialog template based on a configuration interface and input entered by a user.

6. The method of claim 1, further comprising communicating, by the processor, organization information to the user based on the customer profile.

7. The method of claim 6, wherein the communicating is by way of text messages.

8. The method of claim 6, wherein the communicating is by way of email messages.

9. The method of claim 1, wherein the recognizing comprises, recognizing a feature of the user from the image of the user, and associating a preference of the user based on the recognized feature.

10. The method of claim 1, wherein the recognizing comprises, recognizing a prop held by the user from the image of the user, and associating a preference of the user based on the recognized prop.

11. The method of claim 1, further comprising scanning a badge of the user to produce scan data, and wherein the scan data includes the identifier of the user.

12. A computer implemented system of interacting with a user to build a customer profile, the system comprising:
a mirror display system configured to conduct a dialog with the user;
a non-transitory computer readable medium configured to store the customer profile; and
a processor configured to receive an identifier of the user, retrieve personal information of the user from a database system based on the identifier, recognize preference information of the user from an image of the user, obtain additional preference information of the user by managing a dialog between the user and the mirror display system, and store the customer profile based on the personal information, the preference information, and the additional dialog information.

13. The system of claim 12, further comprising a second non-transitory computer readable medium configured to store a plurality of dialog templates, and wherein the processor manages the dialog based on a dialog template that is selected from the plurality of dialog templates.

14. The system of claim 13, wherein the processor is further configured to select the dialog template from the plurality of dialog templates based on the preference information.

15. The system of claim 13, wherein the processor is further configured to select the dialog template from the plurality of dialog templates based on organization information.

16. The system of claim 12, wherein the processor is further configured to communicate organization information to the user based on the customer profile.

17. The system of claim 16, wherein the communicating is by way of at least one of text messages and email.

18. The method of claim 1, wherein the processor is configured to recognize a feature of the user from the image of the user and associate a preference of the user based on the recognized feature.

19. The method of claim 1, wherein the processor is configured to recognize a prop held by the user from the image of the user and associate a preference of the user based on the recognized prop.

20. A multi-tenant enterprise system comprising one or more processors and non-transient computer readable media coupled to the one or more processors, the non-transient computer readable media embodying programming instructions configurable to perform a method, the method comprising:
receiving, by a processor, an identifier of a user;
retrieving, by the processor, personal information of the user from a database system based on the identifier;
recognizing, by the processor, preference information of the user from an image of the user;
obtaining, by the processor, additional preference information of the user by managing a dialog between the user and a mirror display system; and
storing, by the processor, a customer profile based on the personal information, the preference information, and the additional dialog information.
